(19) United States
(12) Patent Application Publication
(10) Pub. No.: US 2007/0193267 A1
(43) Pub. Date: Aug. 23, 2007

(54) Electrical actuator having smart muscle wire

(76) Inventor: Xinhua Sam He, Troy, MI (US)

Correspondence Address: DELPHI TECHNOLOGIES, INC., M/C 480-410-202, PO BOX 5052, TROY, MI, 48007, US

(21) Appl. No.: 11/786,943

(22) Filed: Apr. 13, 2007

Related U.S. Application Data
(62) Division of application No. 10/548,972, filed on Sep. 13, 2005.
(60) Provisional application No. 60/501,279, filed on Sep. 9, 2003.

(51) Int. Cl. F02G 1/04

(52) U.S. Cl. 60/527; 251/11

(57) ABSTRACT

An electrical actuator is characterized by applying electrical current directly to a smart wire to produce an output motion. The smart wire is looped around a drive member that is engaged with a moveable member, fixed at both ends to electrical terminals, and contains one or more coils between the electrical terminals and the drive member. Smart wire coils can either be wrapped around a reel in a helical fashion or moveably disposed in flexible tubing for support. Direct electrical current applied to the smart wire results in heating and contraction of the wire. Subsequent removal of electrical current allows the wire to cool and return to its original size and shape. The force and stroke of the electrical actuator can be tailored to meet specific requirements by changing wire diameter and length.

This application claims priority of U.S. Provisional Patent Application No. 60/501,279 filed Sep. 9, 2003, PCT/US0410/29420 filed Sep. 9, 2004 and U.S. patent application Ser. No. 10/548,972 filed Sep. 13, 2005.

### TECHNICAL FIELD OF INVENTION

This invention relates generally to actuators and more particularly to electrical actuators for operating a mechanical device.

### BACKGROUND OF INVENTION

Mechanical devices, such as power operated automotive closure latches for doors, tail gates and the like, that can be unlatched, unlocked and locked are already known. These mechanical devices closure latches generally include a “power unit” comprising an electric motor or solenoid that operates a plurality of mechanical components including all kinds of gears, springs, slides and levers, that in turn operate the unlatching lever or lock lever of the closure latch. Such power units which depend on an electric motor or solenoid, have one or more of the following drawbacks. The power unit is complex and costly, and/or is sensitive to environmental conditions, and/or is noisy, and/or is subject to wear and/or requires substantial space.

### SUMMARY OF THE INVENTION

This invention provides a “power unit” that is in the form of an electrical actuator that is characterized by applying electrical power directly to a smart muscle wire. The electrical actuator overcomes one or more of the drawbacks of the prior art noted above, particularly with respect to reducing complexity and cost by reducing the number of mechanical components required for the power unit.

Applying electrical current directly to the smart muscle wire produces an output motion for the electrical actuator while eliminating the need for either an electric motor or a solenoid. The smart wire is looped around a drive member that is engaged with a moveable member, fixed at both ends to electrical terminals, and contains one or more coils between the electrical terminals and the drive member. The electrical actuator uses a smart wire to produce an output motion of a moveable member, for example a slide or a lever. The smart wire may be coiled to increase the length of the wire, the coil can either be wrapped around a reel in a helical fashion or moveably disposed in flexible tubing for support. Direct electrical current applied to the smart wire results in heating and contraction of the wire. Subsequent removal of electrical current allows the wire to cool and return to its original size and shape. The force and stroke of the electrical actuator can be tailored to meet specific requirements by changing wire diameter and length. Further features and advantages of the invention will appear more clearly on a reading of the following detail description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a schematic diagram for explaining a characteristic of a smart muscle wire;

FIG. 2 is a stress strain curve of an example of a smart muscle wire;

FIG. 3 is a schematic drawing of an electrical actuator of the invention characterized by a smart muscle wire;

FIG. 3 is an enlarged section of a portion of FIG. 3;

FIG. 5 is a schematic drawing of still another electrical actuator of the invention characterized by a smart muscle wire;

FIG. 5 is a section taken substantially along the line A-A of FIG. 5 looking in the direction of the arrows.

### DETAILED DESCRIPTION OF INVENTION

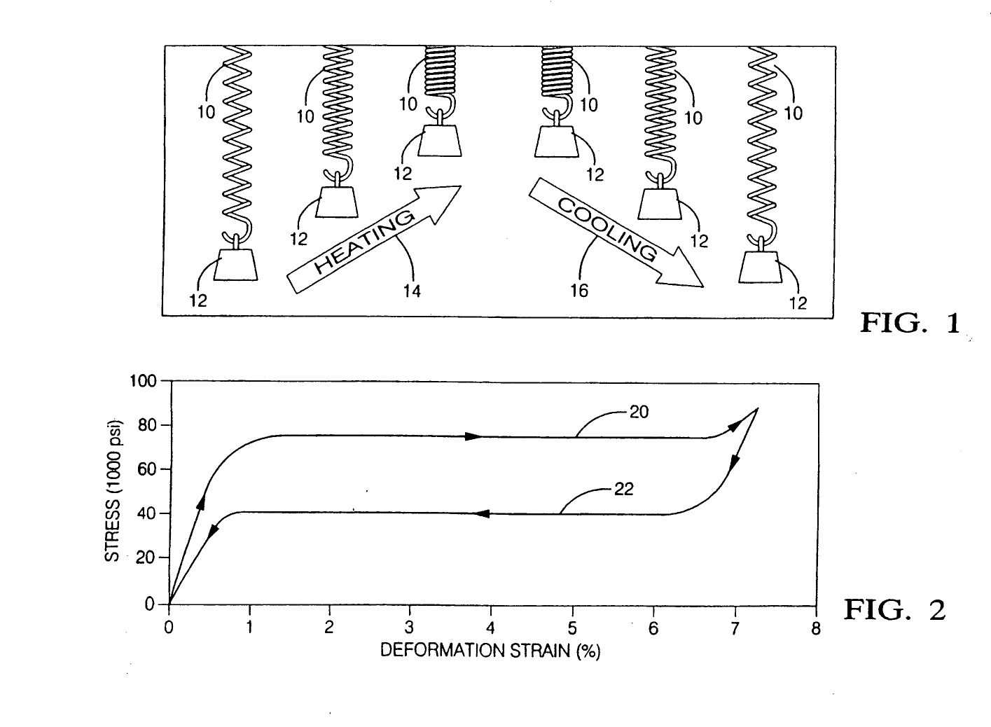

Referring now to the schematic diagram of FIG. 1, a coiled wire 10 made of a smart muscle material is illustrated. Smart muscle material, which is also known as a memory material, is characterized by a shape change responsive to heating and a return to its original shape upon cooling.

An example of a suitable muscle or memory material for the invention is nickel-titanium (NiTi) alloy which expands when heated and contracts when cooled. A wire made of nickel-titanium alloy is represented in FIG. 1 functioning as the coiled wire 10 (of solid round cross section) that supports a weight 12. The electrical resistance of the metallic alloy wire 10 is high so that the wire is heated by applying electric current directly to the wire. The metallic alloy wire expands and contracts between its Martensite and Austentite (phase) transformation which is achieved by heating the wire 10 while it is under the fixed load of weight W. As the metallic alloy wire 10 heats up, wire 10 contracts and raises the weight 12 as indicated by the three left hand figures and the upward slanting heating arrow 14 of FIG. 1. Then as wire 10 cools down, wire 10 expands back to its original shape as indicated by the three right hand figures and the downward slanting cooling arrow 16.

FIG. 2 illustrates the typical loading and unloading that is, the heating and cooling behavior of superelastic nickel titanium (NiTi) alloy. When the material is loaded, the percentage of deformation strain is low initially, that is up to about 1%. The percentage of deformation is then very high increasing up to about 6½% with very little increase in stress. The percentage of deformation strain is then low again. This behavior is shown in the upper curve 20 of FIG. 2. The lower curve 22 shows the behavior of the alloy as the load is removed and the stress returns to zero.

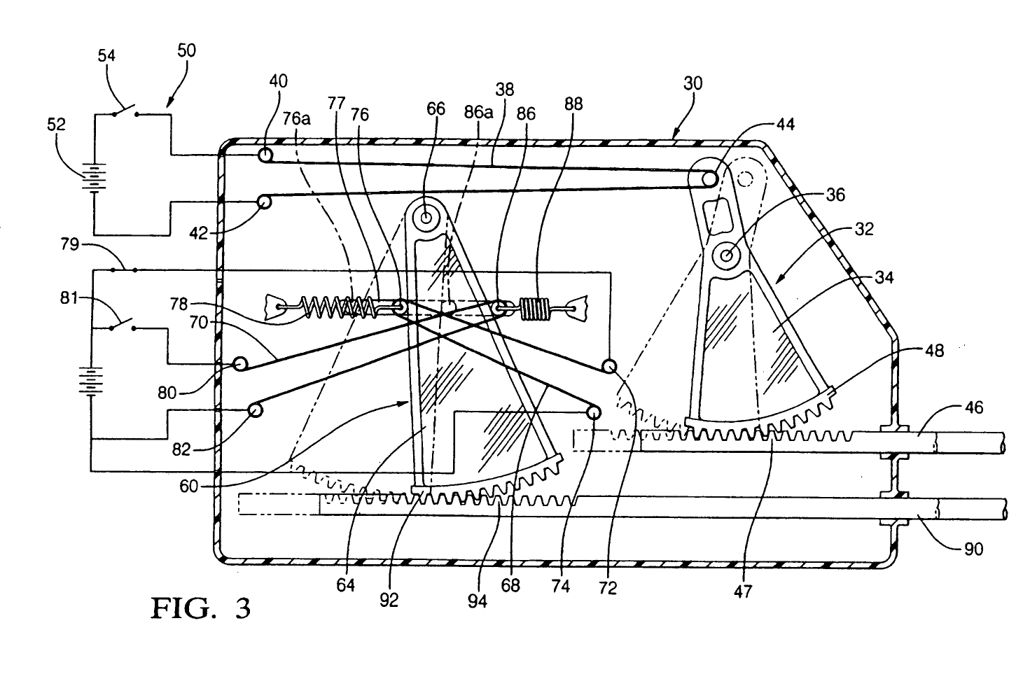

Referring now to FIG. 3, a schematic drawing of an electric actuator 130 of the invention is illustrated. Actuator 130 is designed to operate an unlatching lever of a closure latch (not shown). Consequently electrical actuator 130 is a one-way version 132 (for operating the typical unlatching lever of a closure latch or the like) that reduces the space requirements required to gain a mechanical advantage. Basically the one-way version 132 of electrical actuator 130 simply comprises a slide 134 that is guided by a slide or track 136 and smart muscle wire 138 that contracts when heated and expands when cooled. Wire 138 is fixed to spaced electric terminal 140 and 142 at its respective ends and looped around a drive member 144 that is attached to slide 134 at the left hand end as shown in FIG. 3. When wire 138 is heated, wire 138 contacts moving slide 134 to the right from the phantom line position to the solid line position shown in FIG. 3. Slide 134 in turn may be connected to the unlatching lever of a closure latch (not shown) or the like to move the unlatching lever to the unlatching position.

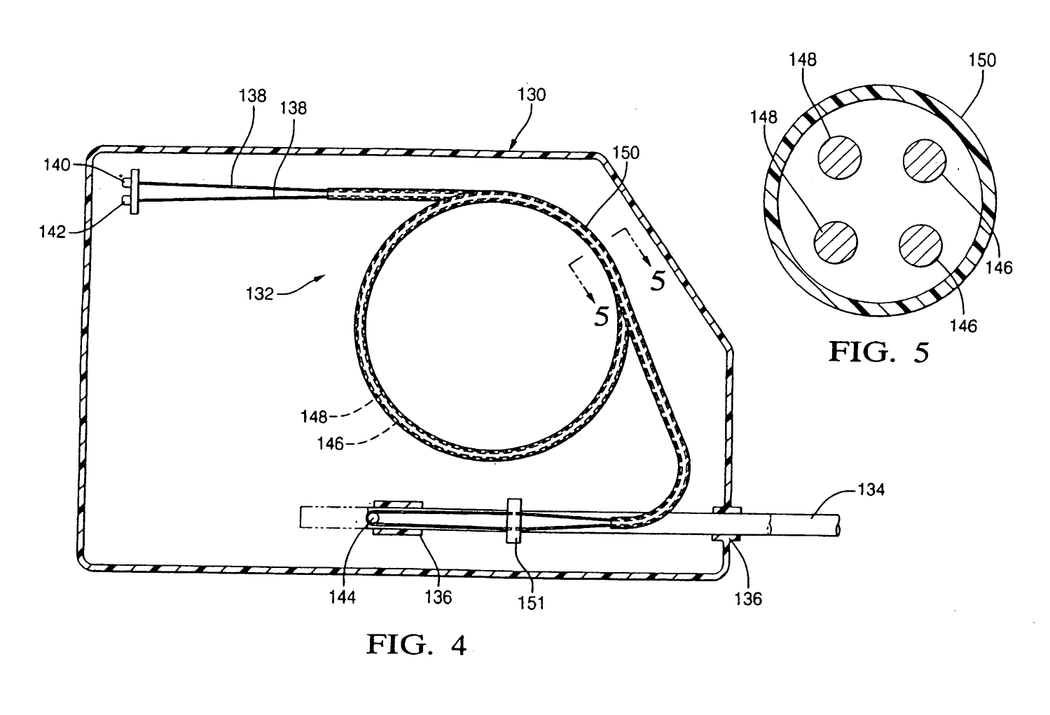

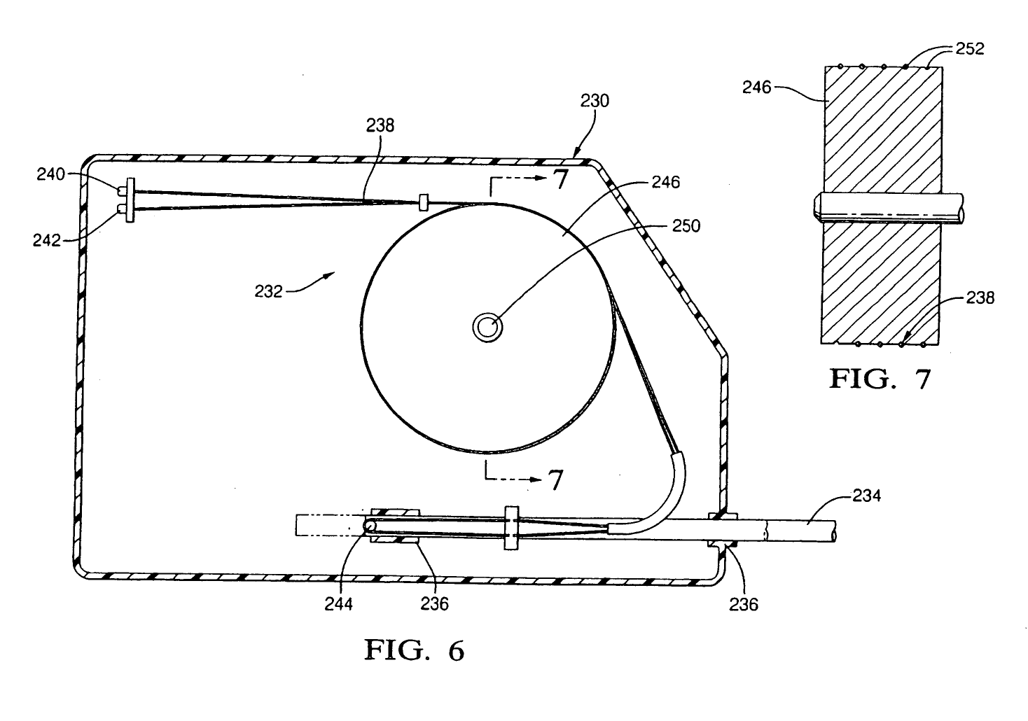

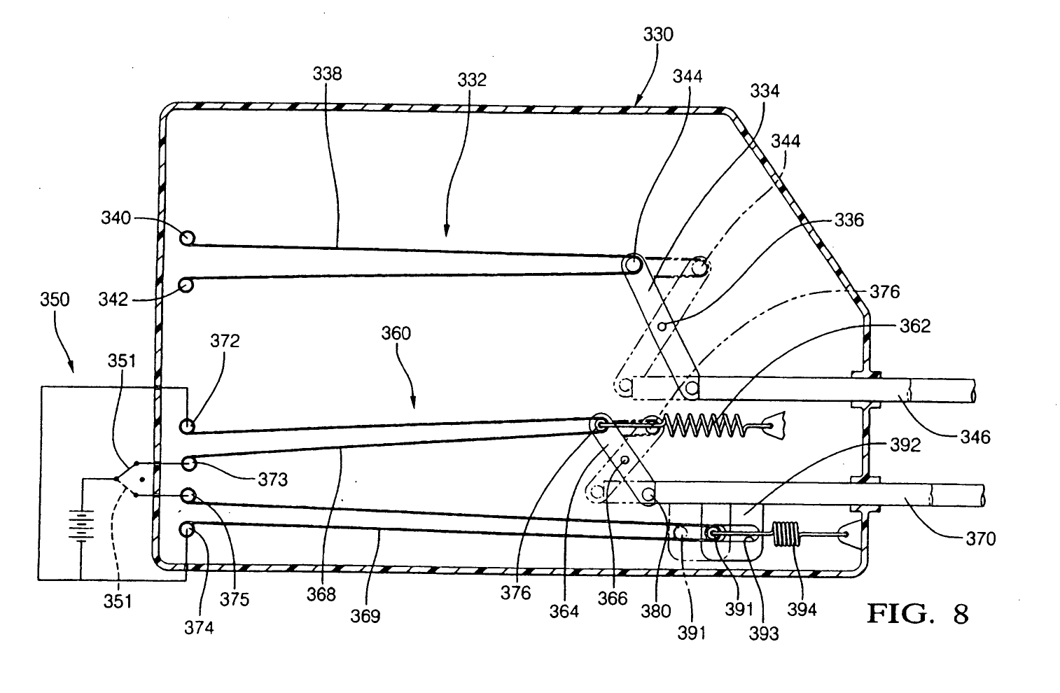

Wire 138 preferably includes one or more coils 146 between terminal 140 and pin 144 and one or more coils 148 between terminal 142 and pin 144 to increase the length of wire 138 in a small space with the increased length increasing the movement or stroke of slide 134. As best shown in FIG. 5, the lengths of wire forming the coils 146 and 148 may be moveably disposed in flexible tubing 150, similar to a bowden cable, to prevent entanglement of the wire in the coils. A wire guide 151 may also be provided.

Smart muscle wire 138 typically has a high electrical resistance and consequently can be heated electrically by a suitable electric circuit connected to terminals 140 and 142 such as circuit 50 that is schematically shown in FIG. 3 and that includes an electrical power source 52 and a switch 54.

One-way version 132 can be converted to a two-way version by using a second smart muscle wire that is connected to a second set of terminals and looped around a drive pin at the right end of slide link 134 to pull slide link 134 to the left when the second wire is heated. Actuator 130 may include both a one-way version and a two-way version.

Referring now to FIG. 5, a schematic drawing of yet another electrical actuator 230 of the invention is illustrated. Actuator 230 is also designed to operate a an unlatching lever of a closure latch (not shown) or the like which typically includes a return spring for the unlatching lever. Consequently actuator 230 is a one-way version 232 for operating the typical unlatching lever of a closure latch or the like that also reduces the space requirements of the actuator 30 which includes lever 34. Basically the one-way version 232 of electrical actuator 230 comprises a slide link 234 that is guided by a slide or track 236 and smart muscle wire 238 that contracts when heated and expands when cooled. Wire 238 is fixed to spaced electric terminal 240 and 242 at its respective ends and looped around a drive pin 244 that is attached to slide link 234 at the left hand end as shown in FIG. 5. When wire 238 is heated, the wire contacts moving slide link 234 to the right as shown by the solid position of slide link 234 in FIG. 5. Slide link 234 in turn may be connected to the unlatching lever of a closure latch (not shown) or the like to move it from one operative position to another.

Wire 238 preferably includes one or more loops between terminal 240 and drive pin 244 and one or more loops between terminal 242 and pin 244 to increase the length of wire 238 in a small space with the increased length increasing the movement or stroke of slide link 234. Actuator 230 includes at least one reel 246 that is located between the terminals 240 and 242 and the slide link 234. Wire 238 is wound around reel 246 between terminal 240 and drive pin 234 and wound around reel 246 between terminal 242 and drive pin 244. Reel 246 preferably has a helical groove 252 to separate loops of wire wound on the reel as best shown in FIG. 6. Reel 246 is also preferably made of a low friction material allowing the wire 238 to slide in the helical groove 252. Reel 246 may also be pivotally mounted on a pivot pin 250.

Smart muscle wire 238 typically has a high electrical resistance and consequently can be heated electrically by a suitable electric circuit connected to terminals 240 and 242 such as circuit 50 that is schematically shown in FIG. 3 and that includes an electrical power source 52 and a switch 54.

The one-way version 232 of actuator 230 can be converted to a two-way version by using a second smart muscle wire that is connected to a second set of terminals looped around a drive pin at the right end of slide link 234 to pull slide link 234 to the left when the second wire is heated.

While the smart muscle wires have been disclosed as being of round solid cross section, other cross sections are possible such as oval or rectangular. Moreover, the smart muscle wires can be tubular rather than solid. Furthermore, the smart muscle wires can be coiled wires.

Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

I claim:

1. An electrical actuator comprising:
a drive member;
a moveable member engaged with said drive member;
at least one smart wire made of a shape memory alloy having two ends, wherein said smart wire is looped around said drive member; and
a electrical terminal connected to each of two said smart wire ends, wherein said terminals are adjacent to each other and spaced from said drive member;
wherein said smart wire has at least one coil located between said electrical terminals and said drive member.

2. The electrical actuator of claim 1 wherein said smart wire is comprised of a nickel-titanium alloy, said smart muscle wire contracts when heated by direct application of electrical current and returns to its original shape upon cooling.

3. The electrical actuator of claim 1 wherein the moveable member is a slide.

4. The electrical actuator of claim 1 containing at least two said smart wires in parallel.

5. The electrical actuator of claim 1 containing a plurality of coils facilitating increased movement of said reaction member and said moveable member.

6. The electrical actuator of claim 5 containing flexible tubing supporting said smart wires, wherein said flexible tubing prevents entanglement of said smart wires in said plurality of coils and wherein said smart wires are moveably disposed in said flexible tubing.

7. The electrical actuator of claim 5 wherein said plurality of coils are wrapped around a reel, said plurality of coils wrapped in helical grooves in said reel to separate said plurality of coils.
